(19) United States
(12) Patent Application Publication
(10) Pub. No.: US 2015/0067762 A1
(43) Pub. Date: Mar. 5, 2015

(54) METHOD AND SYSTEM FOR CONFIGURING SMART HOME GATEWAY FIREWALL

(71) Applicant: SAMSUNG ELECTRONICS CO., LTD., Gyeonggi-do (KR)

(72) Inventors: Evgeny BELENKY, Ramat Gan (IL); Evgeny BESKROVNY, Ramat Gan (IL)

(73) Assignee: SAMSUNG ELECTRONICS CO., LTD., Gyeonggi-do (KR)

(21) Appl. No.: 14/016,276

(22) Filed: Sep. 3, 2013

(51) Int. Cl. H04L 29/06

(52) U.S. Cl. CPC H04L 63/02; H04L 63/20
USPC 726/1

(57) ABSTRACT

A secured smart home system having (a) a smart-home gateway with a firewall protection; (b) plurality of appliances connected to the gateway and located at a secured side of the firewall; and (c) a remote environment classification server located at a non-secured side of the firewall, for providing a firewall policy to the gateway. The gateway submits a list of the appliances to the remote environment classification server, and the classification server provides in response the firewall policy to the gateway.

### FIELD OF THE INVENTION

The invention relates to the field of security in a Smart Home environment. More particularly, the invention relates to a method and system for optimizing in an automatic manner a configuration of a firewall of a Smart Home.

### BACKGROUND OF THE INVENTION

Smart Home systems provide a remote access to various appliances (devices) residing within a home. The access to a variety of home appliances is typically accomplished through a dedicated gateway that shields the appliances that are included within the system from the outside world. Presently, the number of appliances that support Smart Home functionality is relatively small, however, given the fact that the technology is in its initial stages the expectations are that the number of appliances, as well as the variety of environments will significantly increase. The appliances that are positioned behind the Smart Home gateway can be seen as attractive targets to hackers. In order to overcome this problem, and to protect the network from a malicious activity, the appliances behind the gateway are protected by means of a firewall. A Smart Home firewall typically uses a so called deep packet inspection to ensure that the communication traffic through the gateway does not contain suspicious or malicious patterns. A deep packet inspection is very expensive in terms of time and computation resources, as it requires the gateway to use regular expressions or some other verification procedures (i.e., “rules”) to detect those malicious patterns within the transferred packets. As the number of firewall rules increases, a heavy performance impediment is observed within the Smart Home system. In this respect, it should be noted that Smart-Home gateways are typically embodied within one of the controlled appliances (for example, a smart TV), whose computing capability is relatively weak. As a result of this situation, the complication involved in performing a deep packet inspection may significantly affect the whole performance of the Smart Home gateway.

An appropriate configuration of the firewall may significantly improve the performance of the Smart Home system. However, and in contrast to larger systems having professional system managers, a typical user of a Smart Home system does not possess the knowledge for appropriately configuring the firewall. As a result of this situation, Smart Home systems suffer either from low performance, or from a too compromised security.

It is therefore an object of the present invention to significantly reduce the load over a firewall of a Smart Home gateway, without sacrificing its security.

It is another object of the present invention to provide said reduction of gateway load, without requiring a significant user intervention.

It is still another object of the present invention to preform automatic configuration of a firewall of a Smart Home gateway in a manner which is adapted to the respective environment and expected threats.

Other objects and advantages of the invention will become apparent as the description proceeds.

### SUMMARY OF THE INVENTION

The present invention relates to a secured smart home system, which comprises: (a) a smart-home gateway, which comprises a firewall protection; (b) plurality of appliances that are connected to said gateway, said appliances are located at a secured side of said firewall; and (c) a remote environment classification server which is located at a non-secured side of said firewall, for providing a firewall policy to said gateway; wherein the gateway submits a list of said appliances to said remote environment classification server, and the classification server provides in response said firewall policy to said gateway.

Preferably, said classification server comprises a list of predefined environments, each predefined environment being associated with a specific firewall policy, wherein, upon receipt of said list of appliances from said gateway, the classification server determines a suitable environment which best suits said list of appliances, and further selects the firewall policy based on said determined environment.

Preferably, said firewall policy comprises a plurality of firewall rules.

Preferably, said gateway comprises a list of predefined environments, each predefined environment being associated with a specific firewall policy, and wherein, said classification server, upon receipt of said list of appliances from the gateway, determines a suitable environment, and conveys said suitable environment to the gateway, which in turn selects the firewall policy to apply based on said determined environment.

Preferably, said gateway submits to said classification server, in addition to said list of appliances, one or more of additional criteria, and wherein the classification server determines said suitable environment based on said list of appliances and on said additional criteria.

Preferably, said additional criteria comprises a geographic location, language, or native population.

Preferably, said additional criteria comprises an industry identifier.

Preferably, the classification server returns to said gateway more than one firewall policy or more than one suitable environment, enabling a user of the gateway to select a most suitable one, respectively, resulting in applying a firewall policy which involves a partial intervention of the user.

Preferably, the gateway is connected to said classification server via a secured channel.

The invention also relates to a method for applying a firewall policy in a secured smart home, which comprises: (a) providing a plurality of appliances that are located at a secured side of said firewall; (b) submitting a list of said appliances from a gateway at which said firewall is mounted to a remote classification server which is located at a non-secured side of said firewall; (c) based on said list of appliances, determining by said classification server a most suitable environment, and selecting a firewall policy that corresponds to said determined environment; and (d) applying said selected firewall policy within said firewall thereby to protect access to said appliances.

Preferably, in addition to said list of appliances, said gateway submits to the remote classification server additional criteria selected from geographic location, language, native population, or industry identifier.

### BRIEF DESCRIPTION OF THE DRAWINGS

In the drawings:

FIG. 1 describes in a general block diagram form a structure of a Smart Home configuration system, according to a first embodiment of the invention;

FIG. 2 describes in a general block diagram form a structure of a Smart Home configuration system, according to a second embodiment of the invention;

FIG. 3 describes in flow chart form the method according to an embodiment of the invention; and

FIG. 4 describes in a general block diagram form a structure of a Smart Home configuration system, according to a third embodiment of the invention.

### DETAILED DESCRIPTION OF PREFERRED EMBODIMENTS

The present invention is based on the observation that various Smart Home environments require different threat models. The term “environment” is meant to relate to the collection of appliances that are connected to the Smart Home gateway, and their types. For example, the collection of appliances that are included in a Smart Home system at a typical office forms an environment which is different from the collection of appliances that are included in a Smart Home system at a house. In view of this observation, it has been found that there is no real necessity to apply a broadest firewall protection in all typical environments.

The present invention provides a novel system structure which differentiates between various possible Smart Home environments, and adapts the configuration of the firewall to the respective environment and to the associated threats that this specific environment is exposed to. The firewall configuration and the associated protection are provided by the system of the invention substantially without user intervention.

For example, a simple residential network which includes a washing machine, refrigerator and a TV set is not exposed to a large scope of threats, as it is difficult to monetize from a successful penetration to a refrigerator. However, if a residential environment contains a fax machine or equipment of similar or higher complication, for example, medical devices, the scope of protection must preferably set to be much larger. In such latter case, potential attackers may see a greater value in performing various types of attacks. The situation is still substantially different where Smart Home gateway is used in an office where a large number of different types of devices are connected to it. In such a case, it is preferable to apply a full scale of firewall security policy, in order to protect the internal Smart Home network from possible outside attackers. Therefore, the present invention distinguishes between various types of environments, such as a “typical home”, “extended home”, “small office”, “large office”, “store”, etc.

The system of the present invention applies some rules or settings that may be turned On or Off, given the specific environment:
Various injection attacks like SQLi are only relevant if the database is present.
There is a need to inspect outgoing traffic from the network if the firewall is to prevent privacy leakage.

Sometimes there is a need to differentiate access from within the home and from the outside

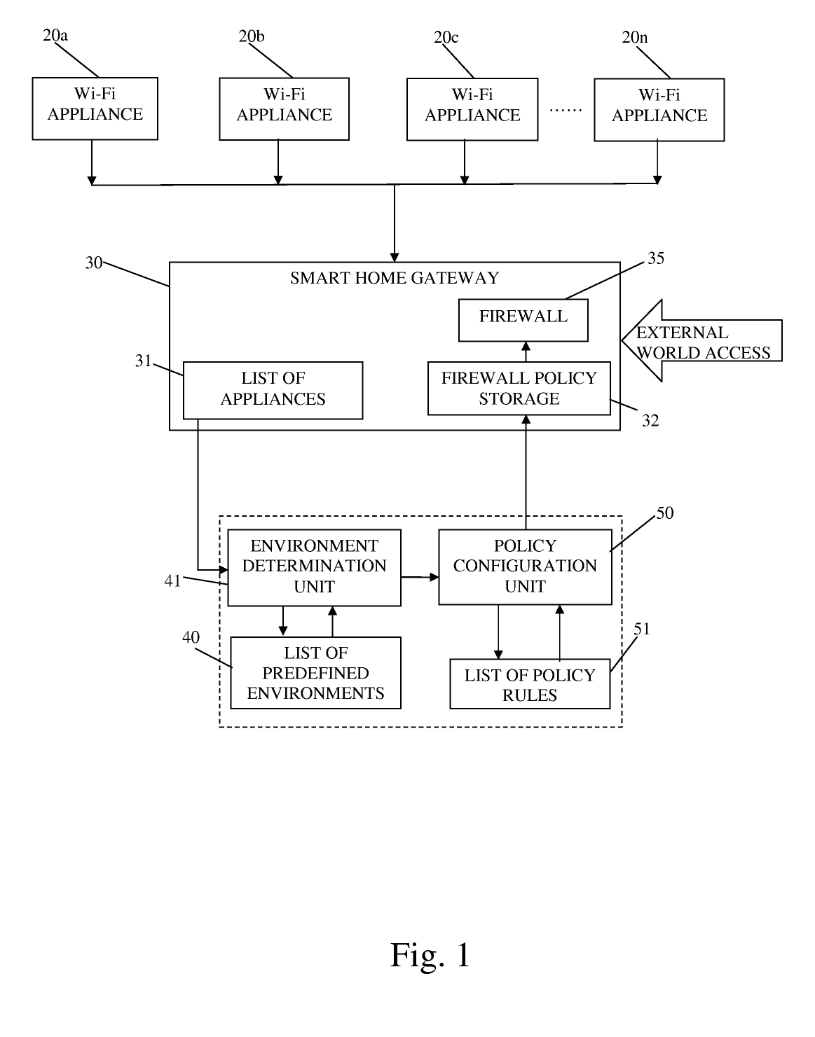

FIG. 1 describes in a general block diagram form a structure of a Smart Home configuration system, according to an embodiment of the present invention. Plurality of appliances 20ₐ, 20_{b}, 20_{c}, . . . 20ₙ are connected to a Smart Home gateway 30 in a manner well known in the art, for example, via a Wi-Fi connection.

Smart Home gateway 30 maintains a list 31 of all the appliances, and their types that are connected to the gateway. For example, the list 31 may contain two smart TVs, one refrigerator, one microwave oven, two stereo units, and a printer. In another example, the list of appliances 31 may contain a TV, one refrigerator, one microwave oven, an SQL server, two printers, a fax machine, and an Intercom. The list may be updated from time to time, based on the appliances that are connected at that time to the Smart Home gateway 30. Having the list of appliances 31, gateway 30 submits this list, particularly the type of the connected appliances to a remote environment classification server 40. Environment determination unit 41 within server 40 compares the list of appliances, as received with a list of predefined environments, to find a best match environment. For example, if said list 31 contains two smart TVs, one refrigerator, one microwave oven, two stereo units, and a printer, the best match environment may be determined as a “small home”. In another example, if the list of appliances 31 contain a smart TV, one refrigerator, one microwave oven, an SQL server, two printers, a fax machine, and an Intercom, the environment may be determined as a “small office”. The environment of unit 41 is then conveyed into a policy configuration unit 50. Policy configuration unit 50 then consults with a list of firewall policy rules 51, and selects the best firewall rules that are suitable to the environment, as received from environment determination unit 41. Policy configuration unit 50 then loads said selected rules into the firewall policy storage 32 within gateway 30. Gateway 30 then activates the firewall 35 based on said firewall policy as stored in firewall policy storage 32. While the firewall is activated, two firewall “sides” are formed, a “secured side” in which all the appliances “reside”, and a “non-secured” side in which the “rest of the world”, including server 40 reside.

Preferably, the two way communication between server 40 and the gateway 30 is conducted over a secured channel.

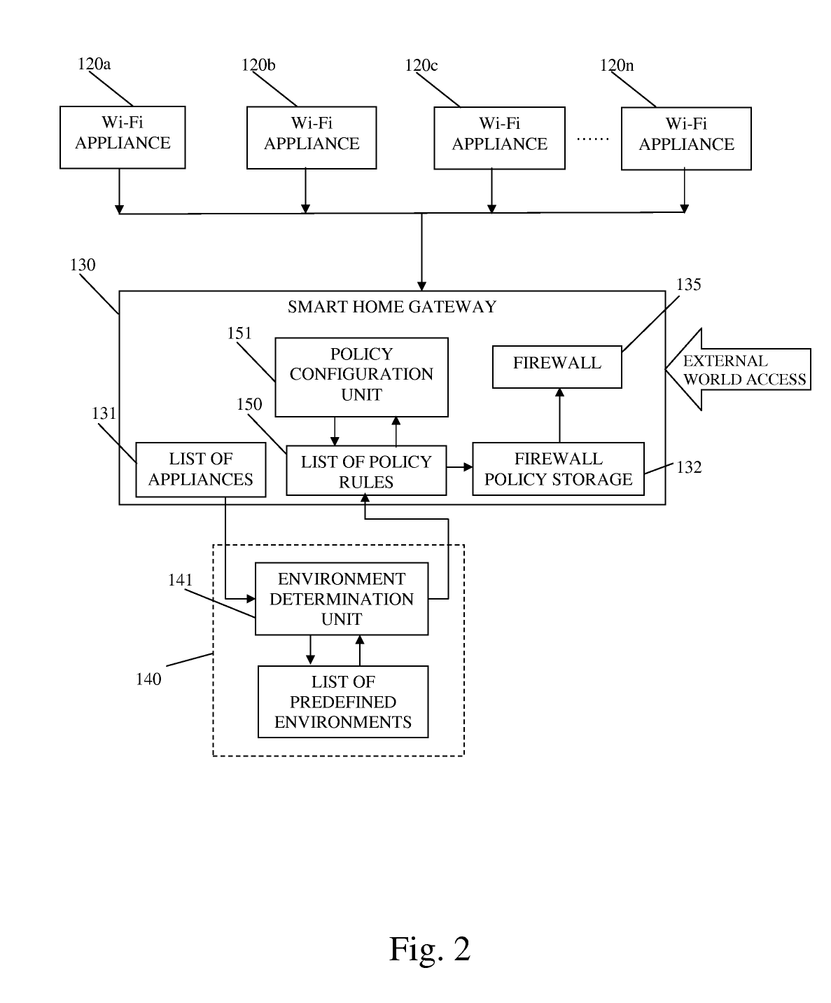

In still another embodiment of the invention shown in FIG. 2, said policy configuration unit 150 and said list of policy rules are located within the gateway. The remote environment classification server 140 conveys the environment, as determined, to the policy configuration unit 150, which configures firewall policy in the same manner as described before with respect to FIG. 1.

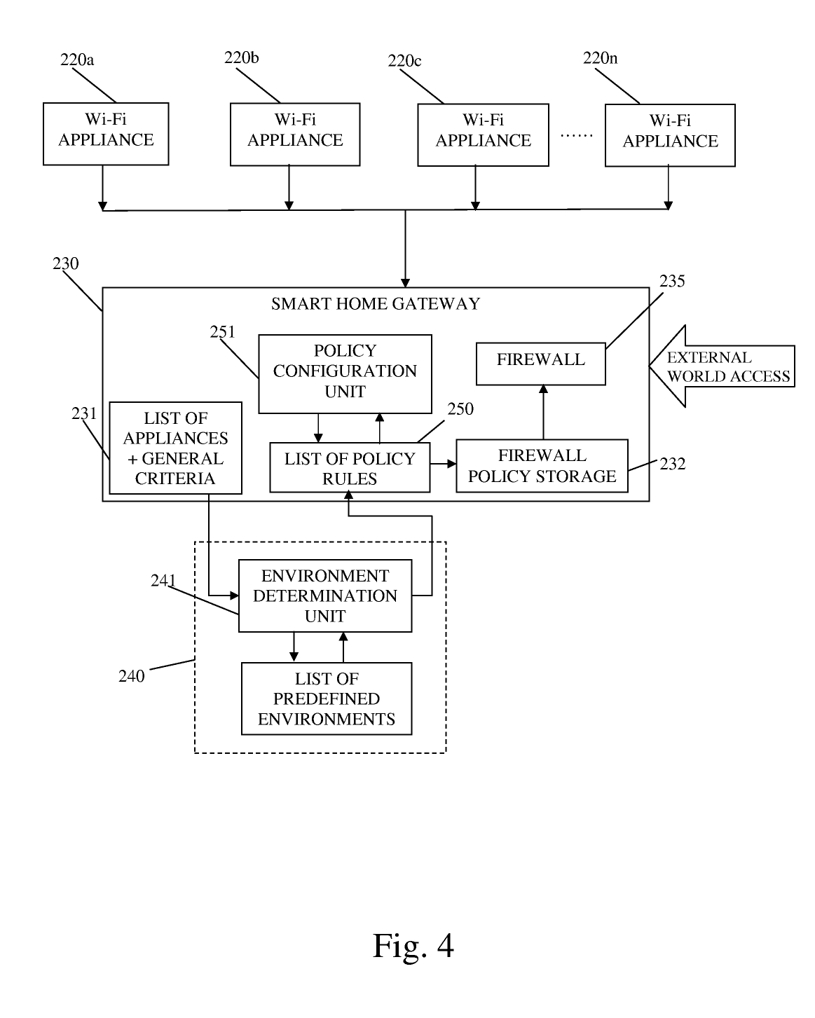

In still another embodiment of the invention shown in FIG. 4, the gateway 230, via its unit 231, may provide to the remote environment classification server 240, in additional to the list of appliances (as in FIGS. 1 and 2), also one or more of general criteria indications 231. The general criteria information is any additional general information that hints to the type of the environment. For example, the criterion may be the industry in which the business is operating in. It is known that certain industries (banking, e-commerce, medical, etc.) are subject to some specific types of threats. Moreover certain industries do use specific platforms that provide special security solutions for their specific needs. For example the travel industry typically uses a Gullivers API for their travel related sites (http://www.hotelsxmlintegration.com/GTA-XML-API-Integration.asp). This platform might have specific problems and by specifying the industry in which the gateway operates, the remote environment classification server 240 can to better fine tune the firewall rules that he selects and send back to the Smart Home Gateway 230.

Still another criterion that may be included is the Smart Home location address. It is typically useful to know the country in which the Smart Home system is located, and, for example, which language is in use at this location. There are intrusion attacks that depend on the language encoding. Knowing the language of the user, may help the server 240 to fine tune the rules, and adding defense rules against attacks that may utilize local specific situations. For example, there are known Cross Site Scripting attacks that manifest themselves only in Japanese encoding ShiftJIS. Enabling a suitable defense rule in all the Smart Home systems may impede the system performance as it is relevant only for Japanese customers (see, for example, http://cve.mitre.org/cgi-bin/cvename.cgi?name=2011-3648). It is important to note that knowledge of the full address may even allow inclusion of this suitable defense rule also in neighborhoods with a big prevalence of people with Japanese nationality.

In still another embodiment, the server may send several firewall configurations to the gateway 230, possibly with some additional assistance information, enabling by this manner the user to select the one configuration which best suits his needs, letting him to consider the tradeoff between performance and security.

As shown, the configuration of the firewall policy of Smart Home gateway 30 is performed automatically, by consulting with the remote environment classification server 40. Therefore, the user of the Smart Home system does not need to be an expert in configuring firewalls, and in fact, he does not need to be an expert at all, as the full configuration of the firewall is performed in an automatic manner. Moreover, the firewall policy which is applied is more suitable to the existing environment, therefore, in most cases at least some of unnecessary firewall rules will not be applied, resulting in a better performance of the gateway, while not scarifying security.

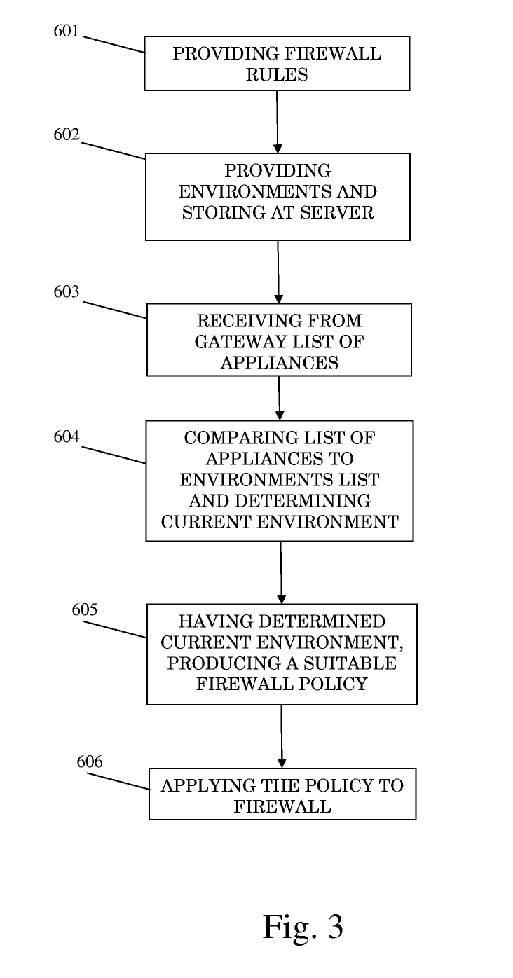

FIG. 3 describes in flow chart form the method according to an embodiment of the invention. In step 601, a list of firewall rules are provided. In step 602, plurality of typical environments are defined, and maintained within a remote server. In step 603, the Smart Home gateway conveys the list of appliances that are connected to it to the remote server. In step 604 the list of appliances, as received from the gateway, is compared with the list of environments to determine a most suitable environment which best matches the collection of appliances to the gateway. In step 605, the determined environment is used in order to construct a most suitable policy. Finally, in step 606 the constructed firewall policy is applied to the gateway firewall.

### Example 1

If collection of connected appliances contains the following list or a combination of devices specified below:
In total, more than 50 registered devices
10 or more PCs
1 or more faxes
1 or more IP cameras
1 or more alarms

Then Server will classify this Smart Home Network as “Office” environment.

In case of the “Office” environment, the following categories of firewall rules will be applied:
SQL injection (50 or more rules)
XSS (10 or more rules)
Denial-Of-Service (10 or more rules)
Authentication and brute force (10 or more rules)
Software Update rules (5 or more rules)
Apply outbound traffic rules (50 or more rules)
Strict Request Flow Enforcement

### Example 2

If the collection of connected appliances contains the following list or a combination of appliances specified below:
1 or more MRI (Magnetic Resonance Imaging) scanners;
1 or more Nuclear medicine scanners;
1 or more CT scanners;
1 or more Ultrasound devices;

Then, the server will classify this Smart Home Network as “Big medical business”, and a suitable policy best matching this environment will be applied.

In the case of the “Big medical business” environment, the following categories of firewall rules will be applied:
SQL injection (50 or more rules)
Denial-Of-Service (10 or more rules)
Authentication rules (10 or more rules)
Access rules (10 or more rules)
Apply rules to outbound traffic (100 or more rules)

### Example 3

If the collection of connected appliances contains the following list or a combination of appliances specified below:
1-2 ECG devices;
1 Ultra sound device1-3;
Blood Analysis devices.

Then, the server will classify this Smart Home Network as “Small medical business” environment.

In the case of the “Small medical business” environment, the following categories of firewall rules will be applied:
SQL injection (50 or more rules);
Denial-Of-Service (10 or more rules);
Authentication rules (10 or more rules);
Access rules (1-5 rules);
Apply rules to outbound traffic (less than 20 rules).

### Example 4

If the collection of connected appliances contains the following list or a combination of appliances specified below:
3 or more Refrigerators;
3 or more Ovens;
2 or more IP cameras;
2 or more alarms;
2 or more Air Conditioners;
1 or more fax machines;
1 or more cash registers.

Then, the remote server will classify this Smart Home Network as “Hospitality Business” (e.g., restaurant, hotel, etc).

In the case of the “Hospitality Business” type, the following categories of Firewall rules will be applied:
SQL injection (50 or more rules);
Apply different rules for indoor and outdoor user (˜100 rules);
Authentication and brute force (10 or more rules);
Access rules (˜50 rules);
Software Update rules (10 or more rules);

### Example 5

If the collection of connected appliances contains the following list or a combination of appliances specified below:
1-3 Smart Phones;
1-3 TVs;
1 Oven;
1-2 Refrigerators;
1 Washing Machine;
1-3 IP cameras;
1 alarm;
1-2 Air Conditioners;
In total, less than 50 devices.

Then, the remote server will classify this Smart Home Network as “House”.

In case of the “House” environment, the following categories of firewall rules will be applied:
Apply different rules for indoor and outdoor user (˜10 rules);
Authentication and brute force (1-2 or more rules);
Software update rules (1-2 rules).

While some embodiments of the invention have been described by way of illustration, it will be apparent that the invention can be carried out with many modifications variations and adaptations, and with the use of numerous equivalents or alternative solutions that are within the scope of persons skilled in the art, without departing from the spirit of the invention or exceeding the scope of the claims.

1. A secured smart home system, which comprises:
a) a smart-home gateway, which comprises a firewall protection;
b) plurality of appliances that are connected to said gateway, said appliances are located at a secured side of said firewall; and
c) a remote environment classification server which is located at a non-secured side of said firewall, for providing a firewall policy to said gateway;
wherein said gateway submits a list of said appliances to said remote environment classification server, and said classification server provides in response said firewall policy to said gateway.

2. System according to claim 1, wherein said classification server comprises a list of predefined environments, each predefined environment being associated with a specific firewall policy, and wherein, upon receipt of said list of appliances from said gateway, the classification server determines a suitable environment which best suits said list of appliances, and further selects the firewall policy based on said determined environment.

3. System according to claim 1, wherein said firewall policy comprises a plurality of firewall rules.

4. System according to claim 1, wherein said gateway comprises a list of predefined environments, each predefined environment being associated with a specific firewall policy, and wherein, said classification server, upon receipt of said list of appliances from the gateway, determines a suitable environment, and conveys said suitable environment to the gateway, which in turn selects the firewall policy to apply based on said determined environment.

5. System according to claim 2, wherein said gateway submits to said classification server, in addition to said list of appliances, one or more of additional criteria, and wherein the classification server determines said suitable environment based on said list of appliances and on said additional criteria.

6. System according to claim 5, wherein said additional criteria comprises a geographic location, language, or native population.

7. System according to claim 5 wherein said additional criteria comprises an industry identifier.

8. System according to claim 1, wherein the classification server returns to said gateway more than one firewall policy or more than one suitable environment, enabling a user of the gateway to select a most suitable one, respectively, resulting in applying a firewall policy which involves a partial intervention of the user.

9. System according to claim 1, wherein the gateway is connected to said classification server via a secured channel.

10. A method for applying a firewall policy in a secured smart home, which comprises:
a) providing a plurality of appliances that are located at a secured side of said firewall;
b) submitting a list of said appliances from a gateway at which said firewall is mounted to a remote classification server which is located at a non-secured side of said firewall;
c) based on said list of appliances, determining by said classification server a most suitable environment, and selecting a firewall policy that corresponds to said determined environment; and
d) applying said selected firewall policy within said firewall thereby to protect access to said appliances.

11. Method according to claim 1, wherein, in addition to said list of appliances, said gateway submits to the remote classification server additional criteria selected from geographic location, language, native population, or industry identifier.

12. System according to claim 4, wherein said gateway submits to said classification server, in addition to said list of appliances, one or more of additional criteria, and wherein the classification server determines said suitable environment based on said list of appliances and on said additional criteria.

13. System according to claim 12, wherein said additional criteria comprises a geographic location, language, or native population.

14. System according to claim 12 wherein said additional criteria comprises an industry identifier.
